(19) United States
(12) Patent Application Publication
(10) Pub. No.: US 2002/0061964 A1
(43) Pub. Date: May 23, 2002

(54) Thermoplastic resin composition and molding thereof

(76) Inventors: Noriyuki Arai, Tokyo (JP); Hiroshi Harada, Osaka (JP); Kazunori Akiyoshi, Niihama-shi (JP)

Correspondence Address: BIRCH STEWART KOLASCH & BIRCH, PO BOX 747, FALLS CHURCH, VA, 22040-0747, US

(21) Appl. No.: 09/939,644

(22) Filed: Aug. 28, 2001

(30) Foreign Application Priority Data
Sep. 4, 2000 (JP) 2000-267075

(51) Int. Cl. C08G 63/48

(52) U.S. Cl. 525/32.2

(57) ABSTRACT

A thermoplastic resin composition comprising 5 to 50 parts by weight of a liquid crystal polyester resin containing at least one selected from the following structural units (1) to (4) and having a flow initiation temperature of 260° C. or less, and 100 parts by weight of a thermoplastic resin having a deflection temperature under load of less than 190°C.:

a structural unit (1) containing the following structural formulae (A₁), (B₂) and (C₁),

a structural unit (2) containing the following structural formulae (A₁), (B₁), (B₂) and (C₁),

a structural unit (3) containing the following structural formulae (A₁), (B₁), (B₂) and (C₂), and

a structural unit (4) containing the following structural formulae (A₁), (B₁), (B₂), (C₁) and (C₂):

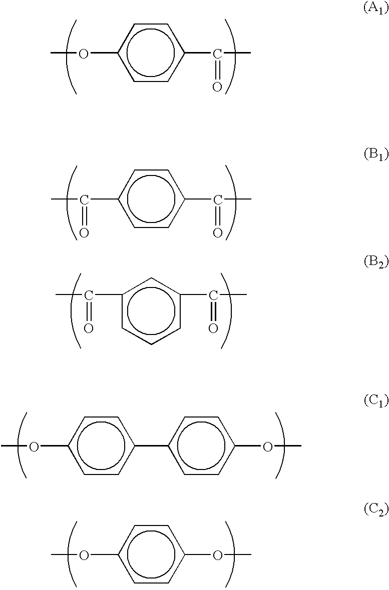

### TECHNICAL FIELD OF THE INVENTION

The present invention relates to a thermoplastic resin composition and a molding thereof. More particularly, the present invention relates to a thermoplastic resin composition which can be utilized in wider fields typically including electric and electronic parts and materials, and manifests excellent flowability without lowering heat resistance and mechanical properties, and a molding thereof.

### BACKGROUND OF THE INVENTION

Thermoplastic resins are used in wider fields typically including electric and electronic parts and materials. Recently, parts have become thin and complicated with size reduction and weight reduction of the parts, consequently, there is a need for a thermoplastic resin which can perform precise molding.

In precise molding, there is a first necessity for improving flowability of a thermoplastic resin used. As a method of improving flowability of a thermoplastic resin, compounding of a liquid crystalline resin is known (for example, JP-B No. 3-45107, JP-A No. 8-118398 and the like). However, there is no detail description regarding process temperatures of thermoplastic resins and liquid crystalline resins used in these methods, and for example, there occur problems that improvement of flowability is not sufficient when temperature at which a liquid crystalline resin can flow is increases by far than temperature at which a thermoplastic resin is melted and that desired physical properties can not be manifested due to thermal deterioration of a thermoplastic resin.

Japanese Patent No. 2505597 discloses a thermoplastic resin composition composed of a thermoplastic resin having a deflection temperature under load of less than 190° C. and a specific liquid crystal polyester resin having a deflection temperature under load of less than 190° C. However, it is known that the liquid crystal polyester resin herein used is a so-called semi-aromatic liquid crystal polyester containing a fatty chain in the main chain, and generally inferior in heat resistance as compared with a whole-aromatic liquid crystal polyester containing no fatty chain in the main chain.

### SUMMARY OF THE INVENTION

An object of the present invention is to provide a thermoplastic resin composition which manifests excellent flowability without losing heat resistance and mechanical properties originally owned by a thermoplastic resin.

That is, the present invention provides a thermoplastic resin composition comprising 5 to 50 parts by weight of a liquid crystal polyester resin containing at least one selected from the following structural units (1) to (4) and having a flow initiation temperature of 260° C. or less, and 100 parts by weight of a thermoplastic resin having a deflection temperature under load of less than 190°C.:

a structural unit (1) containing the following structural formulae (A₁), (B₂) and (C₁),

a structural unit (2) containing the following structural formulae (A₁), (B₁), (B₂) and (C₁),

a structural unit (3) containing the following structural formulae (A₁), (B₁), (B₂) and (C₂), and

a structural unit (4) containing the following structural formulae (A₁), (B₁), (B₂), (C₁) and (C₂):

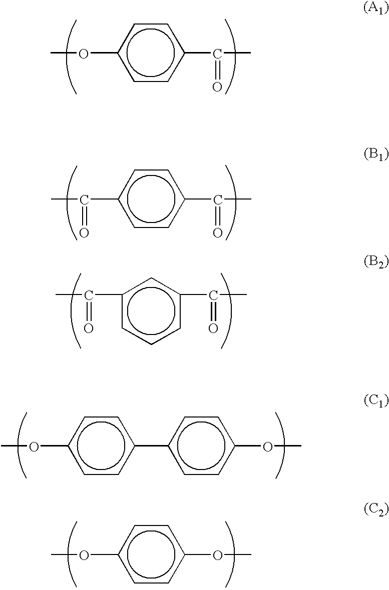

Further, there is provided a molding obtained by molding the above-mentioned thermoplastic resin composition.

### DETAILED DESCRIPTION OF THE PREFERRED EMBODIMENT

The present invention will be illustrated in detail below.

The thermoplastic resin composition of the present invention contains a specific thermoplastic resin and a specific liquid crystal polyester resin in a specific ratio.

The above-mentioned specific liquid crystal polyester resin is a polyester generally referred to as a thermotropic liquid crystal polymer, and is a resin containing one or more selected from the group consisting of a structural unit (1) (a combination containing the above-mentioned structural formulae (A₁), (B₂) and (C₁), a structural unit (2) (a combination containing the above-mentioned structural formulae (A₁), (B₁), (B₂) and (C₁)), a structural unit (3) (a combination containing the above-mentioned structural formulae (A₁), (B₁), (B₂) and (C₂)) and a structural unit (4) (a combination containing the above-mentioned structural formulae (A₁), (B₁), (B₂), (C₁) and (C₂), and having a flow initiation temperature of 260° C. or less, preferably from 200 to 250° C. When the flow temperature is over 260°C., flowability is not excellent in molding. When the flow temperature is less than 200°C., blocking of pellets of a composition is caused, and heat resistance of a molding decreases, undesirably.

In the present invention, the above-mentioned flow temperature means temperature at which the melt viscosity is 4800 Pa·s when a heated melted body is extruded under a load of 100 kg/cm² at a heat raising rate of 4° C./min. using a capillary tube rheometer having a nozzle having an internal diameter of 1 mm and a length of 10 mm.

From the standpoints of heat resistance and processability and the like of the resultant thermoplastic resin composition, it is preferable that the molar ratio (C₁)/(A₁) is from 0.2 to 1.0 and the molar ratio (B₂)/(C₁) is from 0.9 to 1.1, in the above-mentioned structural unit (1). Further, it is preferable that the molar ratios of constituent units in the above-mentioned structural units (2) to (4) are represented as described below: [(C₁) and/or (C₂)]/(A₁)=0.2 to 1.0, [(B₁)+(B₂)]/[(C₁) and/or (C₂)]=0.9 to 1.1, (B₁)/(B₂)=0.1 to 30. (B₁)/(B₂) is further preferably from 0.1 to 0.9, and particularly preferably from 0.1 to 0.3.

Particularly, it is preferable that the molar ratio (C₁)/(A₁) is from 0.2 to 1.0, the molar ratio [(B₁)+(B₂)]/(C₁) is from 0.9 to 1.1 and the molar ratio (B₁)/(B₂) is from 0.1 to 0.9, in the structural unit (2). (B₁)/(B₂) is further preferably from 0.1 to 0.3.

Each liquid crystal polyester resin in the above-mentioned structural units (1) to (4) may contain the following aromatic hydroxycarboxylic acid units, in amount causing no reduction in physical properties of the liquid crystal polyester resin, in addition to the constituents units. The content of this aromatic hydroxycarboxylic acid unit is preferably 5 mol % or less based on (A₁) contained in each structural unit. When over 5 mol %, the heat resistance and mechanical property of a liquid crystal polyester resin sometimes lower.

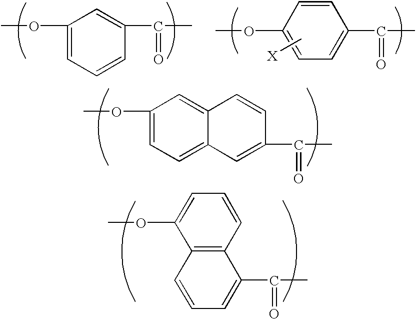

Further, each liquid crystal polyester resin in the above-mentioned structural units (1) to (4) may contain aromatic dicarboxylic acid units and/or aromatic diol units of the following structural formulae, in amount causing no reduction in physical properties of the liquid crystal polyester resin, in addition to the constituents units. The content of this aromatic dicarboxylic acid unit is preferably 5 mol % or less based on (B₁)+(B₂) or (B₂) contained in each structural unit, and the content of this aromatic diol unit is preferably 5 mol % or less based on (C₁) and/or (C₂) contained in each structural unit. In any case, when the content is over 5 mol %, the heat resistance and mechanical property of a liquid crystal polyester resin sometimes lower.

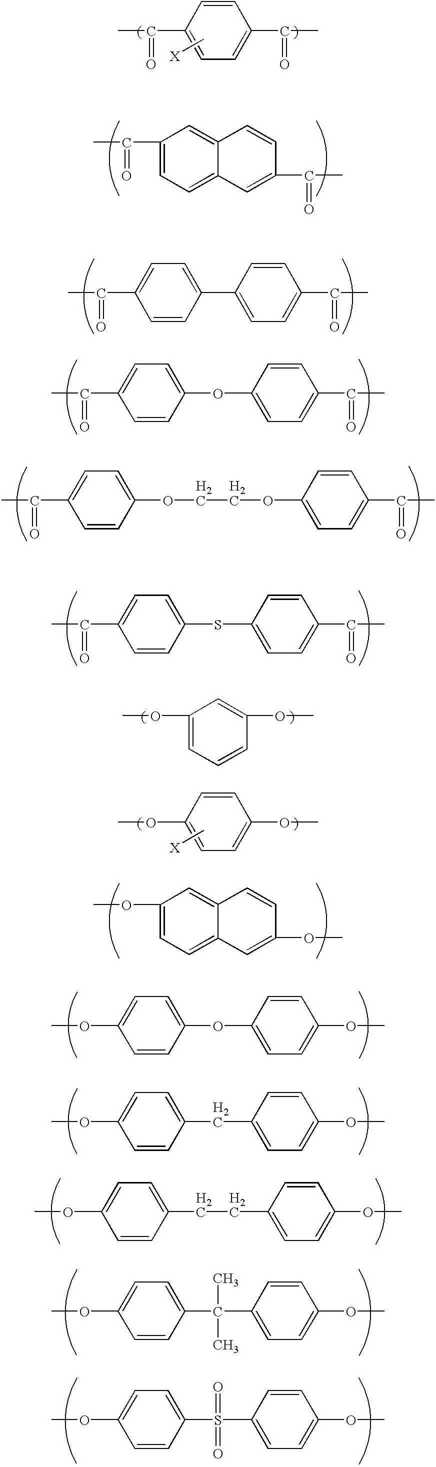

In the thermoplastic resin composition of the present invention, the content of the above-mentioned liquid crystal polyester resin is from 5 to 50 parts by weight, preferably from 10 to 30 parts by weight, based on 100 parts by weight of a specific thermoplastic resin. When less than 5 parts by weight, an effect of improving flowability in molding may be poor, and when over 50 parts by weight, anisotropy of molding contraction ratio of a molding may increase and weld strength may decrease.

The above-mentioned liquid crystal polyester resin used in the present invention can be obtained by appropriately combining known methods.

In the thermoplastic resin composition of the present invention, the above-mentioned specific thermoplastic resin is a thermoplastic resin having a deflection temperature under load of less than 190° C. Such a thermoplastic resin is preferably selected, for example, from polycarbonates, polysulfones, polyarylates, polyphenylenesulfides, polyphenylene ethers, polybutylene terephthalates, polyethylene terephthalates and polyamides, and among them, polycarbonates are preferable. Such thermoplastic resins can be obtained by known methods. In the present invention, commercially available products can also be used.

Specific examples thereof include, but are not limited to, the following compounds.

As the above-mentioned polycarbonate, for example, those composed of hydrocarbon derivatives having a bis(4-hydroxyphenyl), bis(3,5-dialkyl-4-hydroxyphenyl), or bis(3,5-dihalo-4-hydroxyphenyl) skeleton are listed, and of them, those composed of 2,2-bis(4-hydroxyphenyl)propane (trivial name: Bisphenol A) are preferable.

As the above-mentioned polysulfone, a polycondensate of bisphenol A with 4,4′-dichlorodiphenylsulfone is exemplified, and as the above-mentioned polyarylate, a polycondensate of bisphenol A with terephthalic acid and/or isophthalic acid, and the like are listed, for example.

As the above-mentioned polyphenylenesulfide, for example, poly-p-phenylenesulfide and the like are listed, as the polyphenylene ether, for example, poly-p-phenylene ether and the like are listed, and as the polyamide, for example, nylon 6, nylon 46, nylon 66, nylon 610, nylon 11, nylon 12 and the like and copolymers thereof and the like are listed.

In the thermoplastic resin composition of the present invention, a compatibilizing agent can be used if necessary. As the compatibilizing agent, there are listed semi-aromatic liquid crystal polyester resins as described in Polymer Prep. Japan, 36, 3060 (1987), epoxy resins as describer in Polymer, 38, 2947 (1997), and the like. Of them, epoxy resins are preferable from the standpoints of cost and the like, and more preferably, tetraglycidyl-4,4′-diaminodiphenylmethane having an epoxy equivalent of 300 g/eq or less, o-cresol novolak epoxy resin and the like, are desirable.

In the thermoplastic resin composition of the present invention, an inorganic filler may also be contained, if necessary, for the purpose of improving the mechanical property of a molding and the like.

As the inorganic filler, reinforcing materials in the form of fiber or needle such as glass fiber, silica-alumina fiber, wollastonite, potassium titanate whisker and the like; calcium carbonate, dolomite, talk, mica, clay, glass bead and the like are listed, and can be used singly or in admixture in use. Among them, glass fiber is preferable.

The use amount of the inorganic filler is usually from 5 to 100 parts by weight, preferably from 10 to 70 parts by weight based on 100 parts by weight of the above-mentioned thermoplastic resin. When less than 5 parts by weight, a reinforcing effect by the inorganic filler may not be sufficient, and when over 100 parts by weight, molding ability may deteriorate, undesirably.

In the thermoplastic resin composition of the present invention, one or more of coloring agents such as dyes, pigments and the like, and usual additives such as antioxidants, heat stabilizers, ultraviolet absorbers, antistatic agents and the like may also be further contained, if necessary.

As a method of compounding raw material components for obtaining the thermoplastic resin composition of the present invention, a method in which materials is mixed by using a Henschel mixer, tumbler and the like, then, the mixture is melt kneaded using an extruder, and other methods, are listed.

The molding of the present invention is obtained by molding the above-mentioned thermoplastic resin composition, and can be molded into various parts and members according to usual methods.

As a molding method, an injection molding method, compression molding method, extrusion molding method, hollow molding method and the like are listed, and an injection molding method is particularly preferable.

Examples of the molding include electric and electronic parts such as a connector, socket, relay part, coil bobbin, light pick up, vibrator, print wiring board, computer-related parts and the like; semiconductor production process-related parts such as an IC tray, wafer carrier and the like; domestic electric product parts and hosing materials such as a computer, VTR, television, iron, air conditioner, stereo, cleaner, refrigerator, rice boiler, lighting equipment; lighting equipment parts such as a lamp reflector, lamp holder and the like; audio product parts such as a compact disk, laser disk, speaker and the like; communication equipment parts such as an optical cable ferrule, telephone parts, facsimile parts, modem and the like; copy machine-related parts such as a separation nail, heater holder and the like; mechanical parts such as an impeller, fan, toothed wheel, gear, bearing, motor parts, case and the like; automobile parts such as car mechanism parts, engine parts, engine room internal parts, electric equipment parts, interior parts and the like; cooking tools such as a microwave cooking pan, heat resistant dishes and the like; construction materials or civil construction materials such as heat insulation materials like floor materials, wall materials and the like, sound insulation materials, supporting materials like a beam, pillar and the like, roof materials, and the like; aircraft materials, space machine parts, radiation facility parts of a nuclear reactor and the like, marine facility parts, washing jig, optical equipment parts, valves, pipes, nozzles, filters, film, medical equipment parts and medical materials, parts for sensors, sanitary furniture, sport goods, leisure goods, and the like.

### EXAMPLES

The following examples will illustrate the present invention, but do not limit the scope of the present invention.

### Examples 1 to 12, Comparative Examples 1 to 4

The following components were mixed by a Henschel mixed using formulations (by weight) shown in Tables 1 and 2, then, the mixtures were granulated using a twin-screw extruder (PCM-30 type, manufactured by Ikegai Tekko K.K.) at a cylinder temperature of 300° C., to obtain resin composition pellets.

<Component>

Polycarbonate resin: trade name “Caliber 301-30”, manufactured by Sumitomo Dow Limited K. K.

Liquid crystal polyester resins A to I: liquid crystal polyester resins composed of the above-mentioned structural unit (1), having a molar ratio (A₁):(B₁):(B₂):(C₁) of 60:6:14:20, and having a flow initiation temperature of 214° C. in the case of a liquid crystal polyester resin A, 224° C. in the case of a liquid crystal polyester resin B, 232° C. in the case of a liquid crystal polyester resin C, 243° C. in the case of a liquid crystal polyester resin D, 204° C. in the case of a liquid crystal polyester resin E, 221° C. in the case of a liquid crystal polyester resin F, 239° C. in the case of a liquid crystal polyester resin G, 255° C. in the case of a liquid crystal polyester resin H and 288° C. in the case of a liquid crystal polyester resin I.

VectraA950 (Polyplastic K. K.): liquid crystal polyester resin composed of constituent units, p-hydroxybenzoic acid and 2-hydroxy-2-naphthoic acid, and having a flow initiation temperature of 255° C.

Epoxy resin: Sumiepoxy ELM 434 (epoxy equivalent=120 g/eq, manufactured by Sumitomo Chemical Co., Ltd.), Sumiepoxy ESCN195XL7 (epoxy equivalent=195 g/eq, manufactured by Sumitomo Chemical Co., Ltd.)

Glass fiber: trade name “CS03JAPx-1”, manufactured by Asahi Fiber Glass K. K.

Physical properties were evaluated according to the following methods using the resulted pellets. The results are shown in Tables 1 and 2.

<Physical Property Evaluation>

Spiral Flow: A flow length was measured using an injection molding machine (manufactured by Sumitomo Heavy Industries, Ltd., Neomat N110/45) and a spiral flow measuring mold of direct gate mode having a width of 8 mm and a thickness of 1 mm, under conditions of an injection rate of 45 mm/s, an injection pressure of 1400 kg/cm², a heat cylinder temperature of 280° C. and a mold temperature of 80° C.

Bending strength, bending elastic modulus: A test piece having a length of 127 mm, a width of 12.7 mm and a thickness of 6.4 mm was injection-molded, and bending strength and bending elastic modulus were measured according to ASTM D7902.

Tensile strength, tensile elongation: An ASTM dumbbell was injection-molded, and tensile strength and tensile elongation were measured according to ASTM D6382.

Deflection temperature under load: It was measured using a test piece having a length of 127 mm, a width of 12.7 mm and a thickness of 6.4 mm according to ASTM D648, under a load of 18.6 kg/cm².

TABLE 1-(1)

| | Example | | | | | |
|---|---|---|---|---|---|---|
| | 1 | 2 | 3 | 4 | 5 | 6 |
| Caliber 301-30 | 90 | 90 | 90 | 90 | 90 | 90 |
| Liquid crystal | 10 | — | — | — | — | — |
| polyester A | | | | | | |
| Liquid crystal | — | 10 | — | — | — | — |
| polyester B | | | | | | |
| Liquid crystal | — | — | 10 | 10 | 10 | — |
| polyester C | | | | | | |
| Liquid crystal | — | — | — | — | — | 10 |
| polyester D | | | | | | |
| Liquid crystal | — | — | — | — | — | — |
| polyester E | | | | | | |
| Liquid crystal | — | — | — | — | — | — |
| polyester F | | | | | | |
| Liquid crystal | — | — | — | — | — | — |
| polyester G | | | | | | |
| Liquid crystal | — | — | — | — | — | — |
| polyester H | | | | | | |
| Flow initiation | 214 | 224 | 232 | 232 | 232 | 243 |
| temperature (° C.) of | | | | | | |
| liquid crystal | | | | | | |
| polyester resin | | | | | | |
| Sumiepoxy ESCN195XL7 | — | — | — | 0.3 | — | — |
| Sumiepoxy ELM434 | — | — | — | — | 0.3 | — |
| Glass fiber | — | — | — | — | — | — |
| Spiral flow (cm) | 28 | 30 | 24 | 22 | 15 | 22 |
| Tensile strength (MPa) | 61 | 63 | 62 | 62 | 63 | 64 |
| Tensile elongation (%) | 10 | 11 | 12 | 19 | 120 | 24 |
| Bending strength (MPa) | 89 | 92 | 89 | 89 | 91 | 94 |
| Bending elastic modulus | 2530 | 2630 | 2520 | 2440 | 2390 | 2520 |
| (MPa) | | | | | | |
| Deflection temperature | 134 | 134 | — | — | — | 136 |
| under load (° C.) | | | | | | |

TABLE 1-(2)

| | Example | | | | | |
|---|---|---|---|---|---|---|
| | 7 | 8 | 9 | 10 | 11 | 12 |
| Caliber 301-30 | 85.5 | 90 | 90 | 90 | 85.5 | 90 |
| Liquid Crystal | — | — | — | — | — | — |
| polyester A | | | | | | |
| Liquid crystal | — | — | — | — | — | — |
| polyester B | | | | | | |
| Liquid crystal | — | — | — | — | — | — |
| polyester C | | | | | | |
| Liquid crystal | 9.5 | — | — | — | — | — |
| polyester D | | | | | | |
| Liquid crystal | — | 10 | — | — | — | — |
| polyester E | | | | | | |
| Liquid crystal | — | — | 10 | — | — | — |
| polyester F | | | | | | |
| Liquid crystal | — | — | — | 10 | 9.5 | — |
| polyester G | | | | | | |
| Liquid crystal | — | — | — | — | — | 10 |
| polyester H | | | | | | |
| Flow initiation | 243 | 204 | 221 | 239 | 239 | 255 |
| temperature (° C.) of | | | | | | |
| liquid crystal | | | | | | |
| polyester resin | | | | | | |
| Sumiepoxy ESCN195XL7 | — | — | — | — | — | — |
| Sumiepoxy ELM434 | — | — | — | — | — | — |
| Glass fiber | 5 | — | — | — | 5 | — |
| Spiral flow (cm) | 18 | 33 | 27 | 21 | 18 | 20 |
| Tensile strength (MPa) | 68 | 58 | 64 | 64 | 64 | — |
| Tensile elongation (%) | 8 | 8 | 10 | 27 | 10 | — |
| Bending strength (MPa) | 98 | 87 | 92 | 96 | 98 | — |
| Bending elastic modulus | 3227 | 2490 | 2560 | 2500 | 3070 | — |
| (MPa) | | | | | | |
| Deflection temperature | — | 134 | — | 136 | — | — |
| under load (° C.) | | | | | | |

TABLE 2

| | Comparative example | | | |
|---|---|---|---|---|
| | 1 | 2 | 3 | 4 |
| Caliber 301-30 | 100 | 95 | 90 | 90 |
| Liquid crystal polyester I | — | — | 10 | — |
| Vectra A950 | — | — | — | 10 |
| Flow initiation temperature (° C.) | — | — | 288 | 255 |
| of liquid crystal polyester resin | | | | |
| Glass fiber | — | 5 | — | — |
| Spiral flow (cm) | 10 | 10 | 11 | 11 |
| Tensile strength (MPa) | 57 | 62 | — | — |
| Tensile elongation (%) | 130 | 28 | — | — |
| Bending strength (MPa) | 95 | 103 | — | — |
| Bending elastic modulus (MPa) | 2280 | 2820 | — | — |
| Deflection temperature under load (° C.) | 132 | — | — | — |

The thermoplastic resin composition of the present invention is excellent in flowability necessary in molding and also excellent in heat resistance and mechanical property, and can be used suitably in various molded bodies, since a specific liquid crystal polyester resin is compounded in specific ratio into a thermoplastic resin.

What is claimed is:

1. A thermoplastic resin composition comprising 5 to 50 parts by weight of a liquid crystal polyester resin containing at least one selected from the following structural units (1) to (4) and having a flow initiation temperature of 260° C. or less, and 100 parts by weight of a thermoplastic resin having a deflection temperature under load of less than 190° C.:
a structural unit (1) containing the following structural formulae (A₁), (B₂) and (C₁),
a structural unit (2) containing the following structural formulae (A₁), (B₁), (B₂) and (C₁),
a structural unit (3) containing the following structural formulae (A₁), (B₁), (B₂) and (C₂), and
a structural unit (4) containing the following structural formulae (A₁), (B₁), (B₂), (C₁) and (C₂):

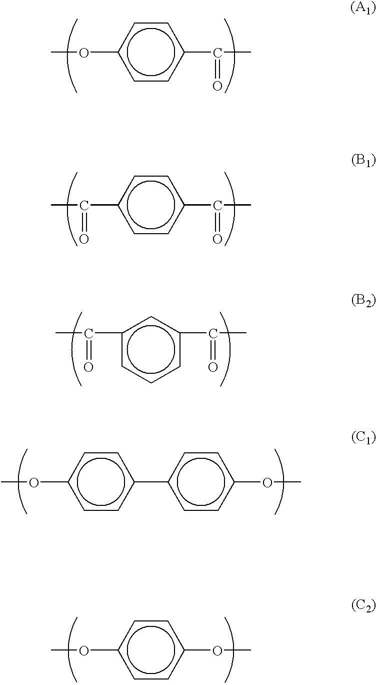

2. The thermoplastic resin composition according to claim 1, wherein the thermoplastic resin having a deflection temperature under load of less than 190° C. is at least one selected from the group consisting of polycarbonates, polysulfones, polyarylates, polyphenylenesulfides, polyphenylene ethers, polybutylene terephthalates, polyethylene terephthalates and polyamides.

3. The thermoplastic resin composition according to claim 1, wherein the liquid crystal polyester resin has a flow temperature of 200 to 250° C.

4. The thermoplastic resin composition according to claim 1, wherein the liquid crystal polyester resin has the structural unit (1), and the molar ratio (C₁)/(A₁) is from 0.2 to 1.0 and the molar ratio (B₂)/(C₁) is from 0.9 to 1.1, in the structural unit (1).

5. The thermoplastic resin composition according to claim 1, wherein the liquid crystal polyester resin has the structural unit (2) to (4), and the molar ratios: [(C₁) and/or (C₂)]/(A₁)=0.2 to 1.0, [(B₁)+(B₂)]/[(C₁) and/or (C₂)]=0.9 to 1.1, (B₁)/(B₂)=0.1 to 30, in the structural units (2) to (4).

6. The thermoplastic resin composition according to claim 1, wherein the liquid crystal polyester resin has the structural unit (2), and the molar ratio (C₁)/(A₁) is from 0.2 to 1.0, the molar ratio [(B₁)+(B₂)]/(C₁) is from 0.9 to 1.1 and the molar ratio (B₁)/(B₂) is from 0.1 to 0.9, in the structural unit (2).

7. The thermoplastic resin composition according to claim 1, wherein the composition further comprises 5 to 100 parts by weight of an inorganic filler.

8. A molding obtained by molding the thermoplastic resin composition according to claim 1.
